(19) United States
(12) Patent Application Publication
(10) Pub. No.: US 2005/0069275 A1
(43) Pub. Date: Mar. 31, 2005

(54) Optical fibre tube sealing

(76) Inventors: Jos Brants, Korbeek-Lo (BE); Pieter De Coster, Bekkevoort (BE); Lodewijk Van Noten, Leuven (BE); Valere Buekers, Zelem-Halen (BE)

Correspondence Address: MYERS BIGEL SIBLEY & SAJOVEC, PO BOX 37428, RALEIGH, NC, 27627, US

(21) Appl. No.: 10/502,200

(22) PCT Filed: Jan. 9, 2003
(86) PCT No.: PCT/GB03/00048

(30) Foreign Application Priority Data
Jan. 23, 2002 (GB) 0201428.0
Apr. 10, 2002 (GB) 0208264.2

(51) Int. Cl. G02B 6/44

(52) U.S. Cl. 385/136; 385/100

(57) ABSTRACT

Apparatus (1) for sealing an optical fibre guide tube or duct (11) from which an optical fibre cable (10) emerges comprises a resilient sleeve (2) having in its unexpanded state an inner diameter smaller than the outer diameter of the optical fibre guide tube (11), and a clamping member (3) for sealingly clamping part of the resilient sleeve (2) around the optical fibre cable (10). The resilient sleeve is preferably made of a thermoplastic elastomer. Resilient sealing material may be introduced into the sleeve while resisting introduction of the sealing material into the interior of the tube or duct.

The present invention relates to optical fibre tube sealing. More in particular, the present invention relates to the sealing of the aperture of a fibre guide tube through which an optical fibre cable protrudes.

In present day optical fibre systems fibre guide tubes (hereinafter also called “fibre tubes” or “tubes”) are used to define fibre trajectories. When first fitted the fibre tubes may be empty, the optical fibres or optical fibre cables being introduced in the fibre tubes at a later stage using suitable techniques such as the air blown fibre technique disclosed in EP 0 108 590 B1 (BT) or the push-and-air-drag technique disclosed in EP 0 292 037 B1 (KPN). Once the optical fibre cables (which term is understood to include single optical fibres) have been introduced in the fibre tubes, the ends of the fibre tubes have to be closed off to prevent any undesired transport of gasses or fluids through the tubes. That is, the gap between the tube opening and any optical fibre cables protruding from the tube must be sealed. It is known to use connectors to mutually connect fibre tubes and to seal the interior of such tubes. Examples of such connectors are disclosed in U.S. Pat. No. 6,053,639 (Chen) and U.S. Pat. No. 5,832,158 (Chen). These connectors are, however, relatively bulky and cannot be used in bends. In addition, they consist of many parts and are therefore relatively expensive.

It is therefore an object of the present invention to profide a device and method which is flexible and inexpensive yet provides an excellent sealing of the ends of the fibre tubes, that is, of the gap between the tubes and the optical fibre cables.

To this end, apparatus for sealing an optical fibre guide tube comprises in accordance with the present invention a resilient sleeve having, in its unexpanded state, an inner diameter smaller than the outer dimention of the optical fibre guide tube, and a clamping member for sealingly clamping part of the resilience sleeve around the optical fibre cable.

The clamping member preferably is a tie-wrap or a metal sleeve. The resilient sleeve is preferably made of a natural or synthetic rubber, and/or a thermoplastic elastomer.

The present invention further provides a method of sealing an optical fibre guide tube, and a kit-of-parts for forming apparatus as defined above and/or for performing the said method.

These aspects of the present invention will now further be explained with reference to the accompanying drawings, in which:

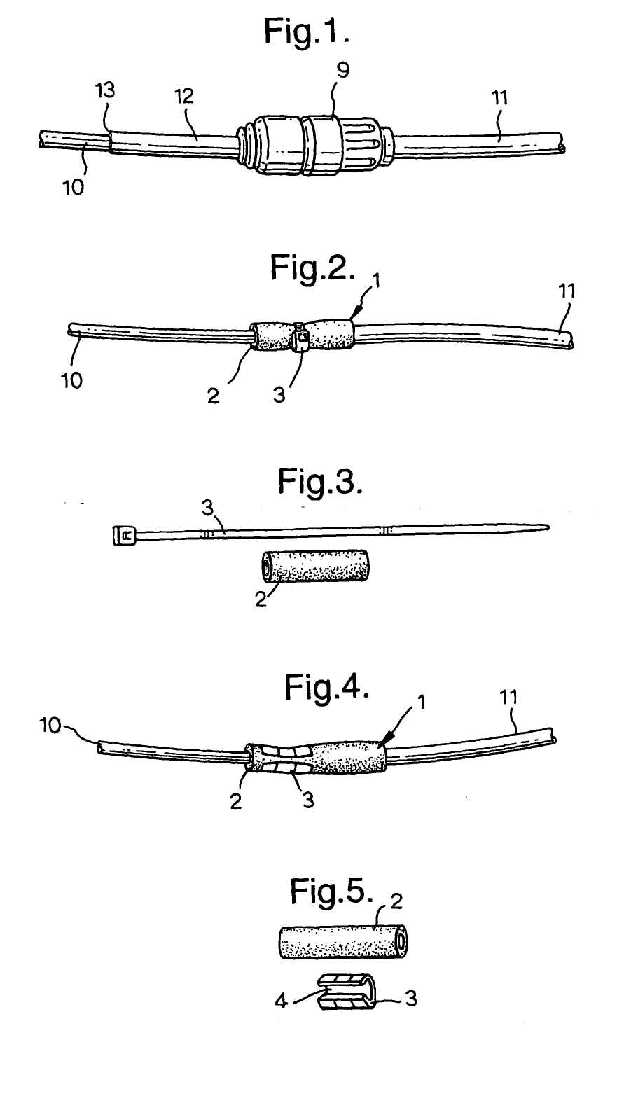

FIG. 1 shows, in perspective, a tube and connector arrangement according to the Prior Art;

FIG. 2 shows, in perspective, a first embodiment of a sealing arrangement according to the present invention;

FIG. 3 shows, in perspective, a kit-of-parts for forming the sealing arrangement of FIG. 2;

FIG. 4 shows, in perspective, a second embodiment of a sealing arrangement according to the present invention; and

FIG. 5 shows, in perspective, a kit-of-parts for forming the sealing arrangement of FIG. 4.

The Prior Art arrangement shown in FIG. 1 comprises a connector 9 connecting a first optical fibre guide tube 11 and a second optical fibre guide tube 12. The connector 20 is arranged so as to internally seal the guide tubes 11 and 12 so no fluids can pass through the aperture 13 from which an optical fibre cable 10 emerges.

In the arrangement shown merely by way of non-limiting example in FIG. 2, a device 1 of the present invention is used to seal the aperture (13 in FIG. 1) of the guide tube 11. The device 1 shown consists of a resilient sleeve 2 and a clamping member 3. The sleeve 2 shown is a thermoplastic elastomer tube the inner diameter of which is, in its unexpanded state, smaller than the outer diameter of the guide tube 11. As a result of this the resilience of the sleeve will cause it to sealingly enclose the end section of the guide tube 11. The clamping member 3 on the other hand clamps the sleeve 2 so as to sealingly enclose the optical fibre cable 10. In this way, a very effective yet inexpensive sealing is achieved. It will be noted that the device 1 is flexible and is smaller than the connector arrangement 20 of FIG. 1.

As shown in FIG. 2, about half the length of the resilient sleeve 2 extends over the tube 11 while the other half extends over the optical fibre cable 10. Other ratios, for example one-third and two-thirds, are of course also possible.

As shown in FIG. 3, the clamping member 3 may be a commercially available tie-wrap.

In the embodiment of FIG. 4 the clamping member 3 consists of a metal sleeve which has sufficient stiffness to permanently clamp the optical fibre cable 10 when deformed. The original shape of the clamping member is shown in FIG. 5. As can be seen, the clamping member of FIG. 5 has a longitudinal slit 4 so as to allow side-entry of the optical fibre cable (“wrap-around”).

It will be understood by those skilled in the art that the present invention is not limited to the embodiments shown and that many additions and modifications are possible without departing from the scope of the present invention as defined in the appending claims.

Further aspects of the present invention relate generally to an improved method and apparatus for sealing at least one elongate element within the interior of a guide duct.

The present invention finds particular utility in the communications industry where widespread use is made of optical fibres for transmitting communication signals. Optical fibres, as is known, are mechanically fragile and require protection from externally applied mechanical forces. For this purpose fibres are coated with a hard coating and frequently grouped together in bundles surrounded by a protective sheath or cable. For many applications, however, it is necessary to be able to assemble individual optical fibres into a communications system, and in such circumstances use is made of individual so-called “blown” fibres. These are fed into a protective guide duct from one end with an accompanying air stream travelling in the same direction, which acts partly as a lubricant and partly to assist in the movement of the fibre along the duct in the space between the interior walls of the duct and any existing fibres already present.

The primary force for introduction of the fibres is, of course, the mechanical force applied to the free end, the air stream being an auxiliary factor assisting in the introduction. The guide ducts for such systems are frequently made as small in diameter as practicable in order to reduce the space occupied by the system of optical fibres, and such ducts are frequently referred to as “micro ducts” although their diameter may in fact be some millimetres if not more. Once the “blown” fibres are introduced into the micro duct it is positioned in its desired location within the system and the end or tails of the optical fibres connected in any known way. Such connection does not form part of the present invention and will therefore not be described further in detail.

It is necessary, for practical purposes in many installations, to ensure that the interior of the micro duct is not subject to gas or liquid penetration which may detrimentally affect the properties of the fibres. Gas-tight and liquid-tight seals are not easily made in the circumstances of an installation site, however, because it is necessary to surround the individual fibres within the duct, as well as to close the end of the duct, and this is further complicated by the fact that the number of fibres within the duct may be anything from one to several dozen, with the lumen ratio (that is the ratio between open space and space occupied by optical fibres) varying from a few percent to well over 90%. In addition, seals should preferably be small in diameter, or rather should not exceed the diameter of the duct by more than is absolutely necessary in order to minimise the transverse dimensions of the ducts. In addition they need to be flexible to accommodate the fact that ducts are required to move within the housing as the optical fibres are connected and also at a later date when changes may be made to the connections of fibres when it is necessary to be able to gain access to previously-connected fibres to disconnect them and/or make fresh connections.

This requirement also means that any seal must be such as to allow re-entry into the interior of the duct either for movement of an existing fibre or, even, for introduction of an additional fibre or additional fibres into the duct using the techniques described above. Above all any system for sealing the interior of the duct must be easy to use by an operator at an installation site at which there may be no more sophisticated equipment than the few hand tools which the installation engineer may carry with him.

One further aspect of the present invention accordingly provides a method of sealing the interior of a hollow duct through which pass one or more elongate elements which project beyond the end of the duct, comprises the steps of introducing one end of the duct into an opening in a sleeve of resilient flexible material the relaxed inner diameter of which is not greater than the outer diameter of the duct, and introducing a mass of a sealing material into the sleeve to surround the said elongate elements while resisting the introduction of the sealing material into the interior of the duct.

The sealing material may, as will be discussed in more detail hereinbelow, be of any suitable type for resisting the ingress of gas and/or liquid, especially water, into the interior of the duct. For this purpose a high viscosity liquid or paste, preferably one having a relatively high surface tension, is suitable, especially one which is waterproof or at least water resistant.

The method of this aspect of the invention may further include the step of physically manipulating the flexible resilient sleeve after the introduction of the sealing material in order to work this around the exterior surface of each of the elongate elements present in the duct to ensure that no spaces between elongate elements, or between the or an elongate element and the sleeve remain to allow the ingress of gas and/or liquid into the interior of the duct. In a simple embodiment such manipulation may be achieved manually, by the installation engineer rolling the flexible sleeve between finger and thumb. Alternatively, a simple roller device for applying a light compression transversely of the sleeve and for causing this to reciprocate laterally (that is transverse the length of the sleeve) under such light compression may be provided. Such device may be manually operated or may be driven by a small motor to cause such reciprocation.

This method of the invention may be performed using a resilient, curable sealing material which forms an adhesive bond with the interior of the resilient flexible sleeve and/or the elongate elements within it. In this case the method of the invention may further comprise the step of curing the said mass of sealing material to bond it to the sleeve and/or to the said elongate elements.

The introduction of the sealing material into the interior of the duct may be resisted in a number of ways. If available, a stream of air from the opposite end of the duct may be applied to cause a positive pressurisation of the interior thereby inhibiting the flow of sealing material along the sleeve from the open end towards the end fitted over the duct. Alternatively the sleeve itself may be subject to a constriction in order effectively to reduce the dimensions of the lumen to such a value that the flow of sealing material along the sleeve is substantially restricted if not prevented. The method of the invention thus may further comprise the step of applying a constriction to the said sleeve between an open end thereof and the said one end of the duct (over which the sleeve is fitted) whereby to resist the entry of the sealing material into the interior of the duct.

Depending on the precise nature of the sealing material it may be introduced into the interior of the sleeve in a number of different ways. A liquid sealant may simply be poured into the open end from an open vessel. One having a greater viscosity, or a paste-like consistency, may be introduced into the interior of the sleeve through an open end thereof by injection, possibly using an injector nozzle. This is facilitated by the flexible resilience of the sleeve material which, unlike the more rigid, stiff material of the micro duct, allows the introduction of a nozzle, enlarging to accommodate it, whilst at the same time allowing the elongate elements (typically optical fibres in the application described above) to be displaced laterally without damage, by adopting a position to one side of and/or surrounding the nozzle as the sealing material is introduced into the interior of the sleeve.

The constriction of the sleeve between the above-mentioned open end and the said one end of the duct may be achieved by the application of a restricting band or other form of external constriction means. In a simple embodiment the band may be of the so-called “tie wrap” type comprising a flexible band having a symmetrical teeth along one face and an opening with a flexible rim engageable by the teeth to form, in use a unidirectional clutch allowing the band to be tightened, but resisting release.

According to another aspect the present invention there is provided apparatus for sealing an end region of a duct bearing elongate elements such as optical fibres, which project beyond the end of the duct, comprising a resilient flexible sleeve engageable over an end region of the duct and through which the projecting parts of the elongate elements can pass, a mass of sealing material for introduction into the sleeve to surround the said projecting parts of the said elongate elements and means for resisting the entry of the sealing material into the interior of the duct.

The sealing apparatus of the invention may further provide means for applying a constriction which restricts the lumen of the sleeve to inhibit the passage of sealing material from one end of the sleeve towards the other. Preferably such constrictions means comprise an external band of variable dimensions surrounding the said sleeve.

The present invention may also be considered to comprehend a kit of parts for use in sealing the interior of a hollow duct through which pass one or more elongate elements such as optical fibres, with the said elongate element or elements in situ and projecting beyond the end region of the duct, comprising a resilient flexible sleeve the relaxed inner diameter of which is not greater than the outer diameter of the duct, means for applying an external constriction to the sleeve whereby to restrict the lumen therein, and means for introducing a mass of sealing material into the interior of the sleeve around the elongate elements.

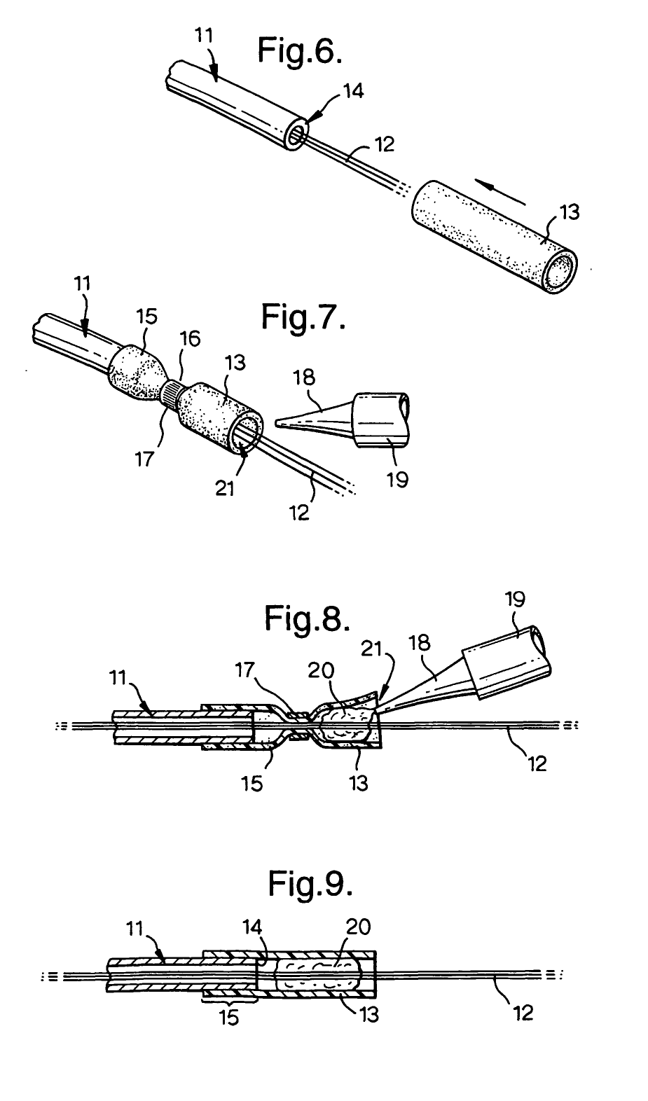

One or more embodiment of these further aspects of the present invention will now be more particularly described, by way of example, with reference to FIGS. 6 to 9 of the accompanying drawings, in which;

FIG. 6 is a schematic view of a micro duct housing a plurality of optical fibres which project from one end;

FIG. 7 is a schematic view illustrating the duct of FIG. 1 with a resilient flexible sleeve fitted thereto;

FIG. 8 illustrates the introduction of sealing material into the open end of the sleeve; and

FIG. 9 is a schematic sectional view of one end of a micro duct sealed against the ingress of gas and/or liquid using the method of the invention.

Referring now to the drawings, FIG. 6 illustrates a micro duct generally indicated 11 into which have been introduced a number of optical fibres 12 by the individual blown fibre technique. A sleeve 13 of resilient flexible material such as an elastomer having a relatively thin wall is shown in close proximity to the end 14 of the micro duct through which the optical fibres 12 project.

FIG. 7 illustrates the sleeve 13 threaded on to the end 14 of the micro duct 11 such that the end 14 is housed within an end portion 15 of the sleeve 13. The nature of the elastomeric material from which the sleeve 13 is made, and the fact that the relaxed interior diameter of the sleeve 13 is less than the external diameter of the micro duct 11 means that the sleeve is held on to the micro duct 11 by friction with a gas-tight and water-tight seal between the material of the sleeve 13 and that of the micro duct 11. Also visible in FIG. 7 is a constriction 16 applied by an external band 17 placed around the sleeve 13 just beyond the end region 15 into which the micro duct 11 reaches. The band 17 may be a so-called tie wrap capable of applying a constricting force when tightened on to the sleeve 13.

As can be seen in FIG. 8 a nozzle 18 of a container 19 for a mass of a suitable sealant material 20 (see FIG. 9) is shown being introduced into the open end 21 of the sleeve 13. As can be seen in FIG. 8 the relatively thin wall of the sleeve 13 allows the end 21 to be enlarged by the introduction of the nozzle 18, pushing the optical fibres 12 to one side without applying any significant force which would detrimentally affect their optical properties, so that a mass of a sealant material, in this case a liquid curable silicone, can be introduced into that portion of the lumen of the sleeve 13 between the constriction 16 exerted by the band 17 and the open end 21.

The sealing of the optical fibres 12 into the micro duct 11 then proceeds by a manipulation (not illustrated) of the free end portion of the sleeve 13, which may take place by the installation engineer using finger and thumb to “roll” the sleeve between them causing the silicone material 20 to be “massaged” around the optical fibres 12 to form a good, intimate contact with them and with the interior surface of the sleeve 13. The silicone material is an economic non-toxic material which is easy to install and readily available. For convenience individual “one-shot” packs may be provided, which may contain just sufficient silicone material 20 to form a plug within the sleeve 13 of a given dimension so that the dispenser nozzle 18 can be discarded after use without any requirement for complex or unreliable techniques for preventing curing of the material remaining within the nozzle. In this way any material remaining within the nozzle after the plug 20 has been introduced can be safely discarded.

As discussed above one advantage of this system lies in its reliability in forming a secure gas and water-tight seal around the optical fibres 12 to prevent the ingress of gas and/or water into the micro duct 11, whilst nevertheless allowing re-entry into the micro duct, by gently pulling the sleeve 13 from it, at a later date should it be necessary and/or desirable to make changes to the configuration of the optical fibres.

1. An apparatus for sealing an optical fibre guide tube from which an optical fibre cable emerges, the device comprising:
a resilient sleeve having in its unexpanded state, an inner diameter smaller than an outer diameter of the optical fibre guide tube, and
a clamping member for sealingly clamping at least part of the resilient sleeve around the optical fibre cable.

2. An apparatus according to claim 1, wherein the resilient sleeve comprises a thermoplastic elastomer.

3. An apparatus according to claim 1, wherein the clamping member is plastic.

4. An apparatus according to claim 1, wherein the clamping member comprises a metal sleeve.

5. An apparatus according to claim 4, wherein the metal sleeve allows side-entry of the optical fibre cable.

6. An apparatus according to claim 1 wherein the apparatus has a length of between 2 centimeters (cm) and 6 cm.

7. A method of sealing an optical fibre guide tube from which an optical fibre cable emerges, the method comprising:
fitting a resilient sleeve over an end portion of the optical fibre guide tube, the resilient sleeve having an inner diameter smaller than an outer diameter of the end portion; and
fitting a clamping member around a part of the resilient sleeve enclosing the optical fibre cable so as to seal any gap between the resilient sleeve and the optical fibre cable.

8. A method according to claim 7, wherein the resilient sleeve comprises a thermoplastic elastomer.

9. A method according to claim 7, wherein the clamping member comprises a metal sleeve.

10. A method according to claim 7, wherein the optical fibre guide tube is configured for use with air blown fibre.

11. A method of sealing an interior of a hollow duct through which passes at least one elongate element which projects beyond the end of the hollow duct, the method comprising:
introducing one end of the hollow duct into one end of a sleeve of resilient flexible material, a relaxed inner diameter of which is not greater than an outer diameter of the hollow duct, and
introducing a mass of a resilient sealing material into the sleeve to surround the at least one elongate element while resisting the introduction of the resilient sealing material into the interior of the hollow duct.

12. A method as claimed in according to claim 11, further comprising curing the mass of sealing material to bond it to the sleeve and/or the at least one elongate element.

13. A method according to claim 11, further comprising applying a constriction to the sleeve between an open end thereof and the one end of the hollow duct to resist entry of the sealing material into the interior of the hollow duct.

14. A method according to claim 11, wherein the mass of sealing material is introduced into of the sleeve through an open end thereof by injection.

15. A method according to claim 11, further comprising manipulating the mass of sealing material by manual and/or mechanical means after introduction thereof into the sleeve.

16. (Canceled).

17. An apparatus for sealing an end region of a duct carrying at least one elongate element, such as an optical fibre, which projects beyond an end of the duct, the apparatus comprising:
a resilient flexible sleeve engageable over an end region of the duct and through which a projecting part of the elongate element can pass;
a mass of flexibly resilient sealing material introduced into the sleeve to surround the projecting part of the elongate element; and
means for resisting entry of the sealing material into an interior of the duct.

18. An apparatus according to claim 17, wherein the sleeve includes constriction means for restricting a lumen of the sleeve to inhibit passage of sealant material from one end of the sleeve towards an opposite end of the sleeve.

19. An apparatus according to claim 18, wherein the constriction means comprises an external band surrounding the sleeve.

20. An apparatus for use in sealing an interior of a hollow duct through which passes at least one or more elongate element, such as optical fibres, with the at least one elongate element or elements in situ and projecting beyond an end region of the duct, the apparatus comprising;
a resilient flexible sleeve having a relaxed inner diameter not greater than an outer diameter of the hollow duct;
means for applying an external constriction to the sleeve whereby to restrict a lumen therein; and
means for introducing a mass of sealant material into an interior of the sleeve around the at least one elongate element.

21. (Canceled).

22. A kit-of-parts for forming the apparatus of claim 1.

23. An apparatus according to claim 3, wherein the clamping member comprises a tie-wrap.

24. A method according to claim 7, further comprising introducing a mass of resilient sealing material into the sleeve; and
curing the mass of sealant material to bond it to the sleeve and/or the optical fibre cable.

25. A method according to claim 24, further comprising applying a constriction to the sleeve to resist entry of the sealing material into the optical fibre guide tube.

26. A method according to claim 24, wherein curing the mass of sealant material is preceded by manipulating the mass of sealing material by manual and/or mechanical means after injection thereof into the sleeve.

27. An apparatus according to claim 1, further comprising:
a mass of flexibly resilient sealing material in the sleeve and surrounding the optical fibre cable; and
means for resisting entry of the sealing material into an interior of the optical fibre guide tube.

28. An apparatus according to claim 27, further comprising constriction means for restricting a lumen of the sleeve to inhibit passage of the sealing material in the sleeve.

29. An apparatus according to claim 28, wherein the constriction means comprises an external bound surrounding the sleeve.
